(19) United States
(12) Patent Application Publication
(10) Pub. No.: US 2008/0104881 A1
(43) Pub. Date: May 8, 2008

(54) Fishing lure

(76) Inventor: Koichi Ito, Shizuoka (JP)

Correspondence Address: KRATZ, QUINTOS & HANSON, LLP, 1420 K Street, N.W., Suite 400, WASHINGTON, DC, 20005, US

(21) Appl. No.: 11/819,060

(22) Filed: Jun. 25, 2007

(30) Foreign Application Priority Data
Nov. 7, 2006 (JP) 2006-301840

(51) Int. Cl. A01K 85/00

(52) U.S. Cl. 43/42.47

(57) ABSTRACT

A fishing lure includes a lure body formed to have an appearance imitating a small fish. The lure body is provided with a bendably structured diving plate in the vicinity of the tip of the lure body. The diving plate is made to be bendable by connecting the upper portion and the lower portion of the diving plate bendably in a manner that the lower portion is vertically pivotable in regard to the upper portion fixed on the lure body.

### CROSS-REFERENCE TO RELATED APPLICATIONS

This application is based upon and claims the benefit of priority from the prior Japanese Patent Application No. 2006-301840, filed on Nov. 7, 2006, the entire contents of which are incorporated herein by reference.

### BACKGROUND OF THE INVENTION

1. Field of the Invention

The present invention relates to a fishing lure.

2. Description of the Related Art

In lure fishing, lures of various shapes, sizes, and devices according to the type or the like of a target fish have been devised. For instance, when a big fish, the so-called fish eater, which mainly eats a small fish as diet is the target fish, a lure having the shape imitating a small fish is used. Devices on shapes or colors of the lure have been made to attract target fishes, in other words, in order to obtain the effect of being strongly appealing to the target fishes so as to be more attractive to them.

For an appeal effect for the target fishes of this kind of lure, not only a shape but also a lure action performed by the lure during moving around in the water is an important point. Especially, for a lure having a lip (diving plate) in the vicinity of the tip of the lure body, the lure depicts a locus of swimming while performing a lure action by receiving stream resistance by the lip during swimming. For instance, a lure described in Patent Document 1 has a lip in a plate structure protruding from the lure main body.

(Patent Document 1) Japanese Patent Application Laid-open No. 2004-57203

A lure provided with the above-described lip is cast aiming at a target point, and the lure is forced to move in the water by pulling a fishing line after landing on the water. In the conventional lures, there have been problems that the lip receives air resistance at the time of casting, which causes an irregular rotational movement or an insufficient flying distance of the lure. Furthermore, although it is usually expected to enhance an appeal effect to the target fishes by making the lure bear a variety of lure actions, it is not necessarily easy to change the lure action and the track of the lure movement during moving around in the water, because the lip of a conventional lure is a fixed type. These factors sometimes affect the result of fishing.

### SUMMARY OF THE INVENTION

Under these circumstances, an object of the present invention is to provide a fishing lure excellent in casting performance and possible to realize an effective lure action.

The fishing lure of the present invention provided with a lure body formed in an appearance imitating a small fish in shape includes a diving plate in the vicinity of the tip of the above-described lure body, in which the diving plate is structured to be bendable.

Furthermore, in the fishing lure of the present invention, the above-described diving plate is bendable by pivotably connecting the upper portion and the lower portion of the diving plate relatively to each other, and by vertically pivoting the lower portion in regard to the upper portion fixed on the above-described lure body.

Still further, in the fishing lure of the present invention, the upper portion and the lower portion of the above-described diving plate are attached to each other by a pin connection, and an engaging portion where the upper portion and the lower portion are put on top of one another in a concave and convex combination state is provided at a portion very close to the connecting point so that the above-described diving plate can be kept in a flush state owing to this connecting portion.

### BRIEF DESCRIPTION OF THE DRAWINGS

FIG. 1 is a side view of a fishing lure relating to the embodiment of the present invention;

FIG. 2 is a front view of the fishing lure relating to the embodiment of the present invention;

FIGS. 3A and 3B are the front and the side views showing the structural example of a diving plate relating to the embodiment of the present invention;

FIG. 4 is the side view showing an operation of the diving plate relating to the embodiment of the present invention; and

FIGS. 5A and 5B are respective front views showing modifications of the fishing lure relating to the embodiment of the present invention.

### DETAILED DESCRIPTION OF THE PREFERRED EMBODIMENTS

Hereinafter, preferable embodiments of a fishing lure according to the present invention will be explained in detail based on the attached drawings.

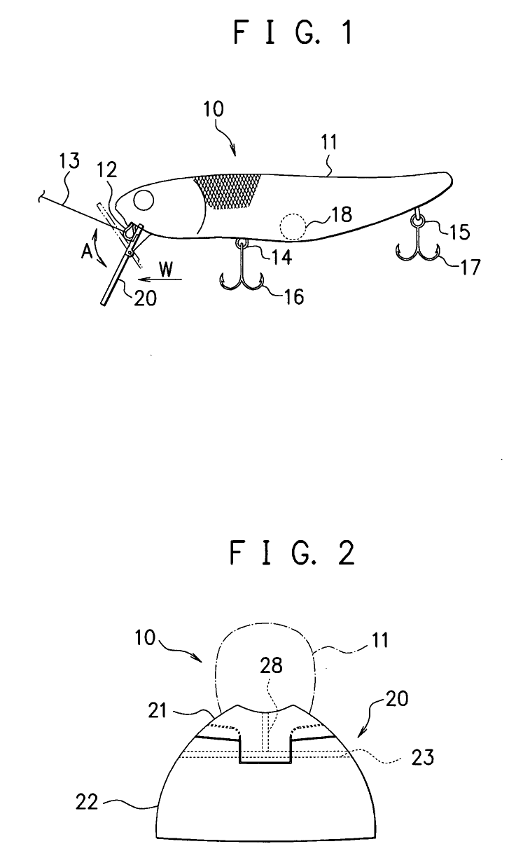

FIG. 1 shows an example of a fishing lure 10 in the present embodiment. In the drawings, the numeral number 11 is a lure body, which is formed so as to have an appearance imitating a small fish made of material such as plastic or the like. In this embodiment, the lure body 11 is integrated by abutting light and left two body halves to each other, which are formed by dividing it along the longitudinal direction (in front and behind) of the lure body 11 each other to have a hollow structure.

Moreover, the numeral number 12 is a string ring provided at the tip of the lure body 11, and a fishing line 13 is connected to the string ring 12. Further, the numeral number 14 is a hook hunger and the numeral number 15 is also a hook hunger, and a front hook (fishing hook) 16 and a rear hook 17 attach to these hungers. Furthermore, a metal balance weight 18 is usually embedded in the inside of the lure body 11 as necessary. There may be one or more weights as the balance weights 18 which is or are fixed at a predetermined place in the lure body 11 or movably attached along the longitudinal direction of the lure body 11.

Furthermore, the numeral number 20 is a diving plate (so-called lip, which will be described later in detail), which is annexed in the vicinity of the tip of the lure body 11. The diving plate 20 is formed in a thin plate, and is set so as to properly slant downward (typically slanting forward and downward) in regard to the lure body 11. By forming in this way, the lure 10 can take a diving attitude by pulling the fishing line 13. In the present invention, the diving plate 20 is formed particularly to be bendable. The diving plate 20 can be in a flush state, and at least one portion thereof is bent so as to be folded toward the front of the lure body 11.

In this embodiment, an upper portion 21 and the lower portion 22 of the diving plate 20 are bendably connected as shown in FIG. 2, and the diving plate 20 is bendable by vertically pivoting the lower portion 22 in regard to the upper portion 21 fixed to the lure body 11 (refer to FIG. 1, arrow A).

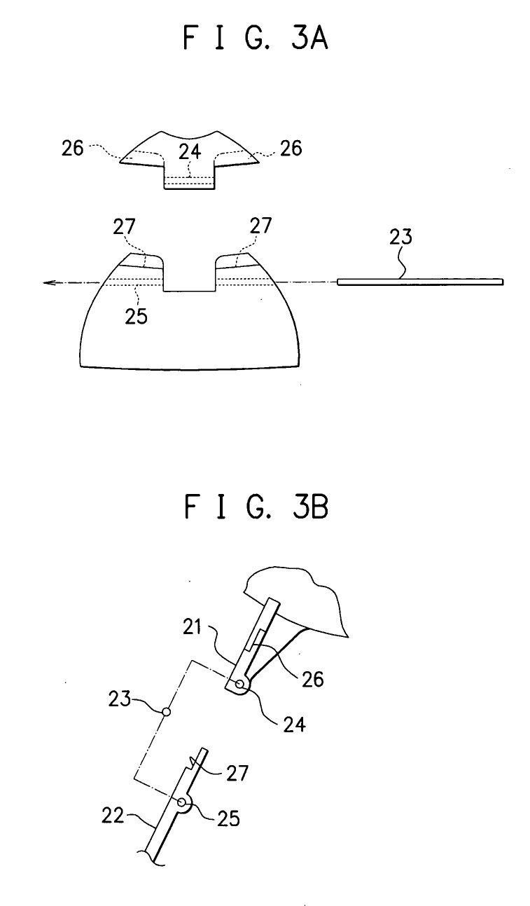

In a specific formation of the diving plate 20, the upper portion 21 and the lower portion 22 are attached to each other by a pin-connection via a pin 23. As shown in FIGS. 3A and 3B, the upper portion 21 and the lower portion 22 are provided with pin inserting holes 24 and 25 respectively where the pin 23 inserts through, so that the lower portion 23 pivots around the pin 23. At a portion very close to the connecting point which is formed by inserting the pin 23 through the pin inserting holes 24 and 25, engaging portions 26 and 27 where the upper portion 21 and the lower portion 22 are designed to be put on top of one another in a concave and convex combination state are formed, so that the diving plate 20 can be kept in a flush state with these engaging portions 26 and 27.

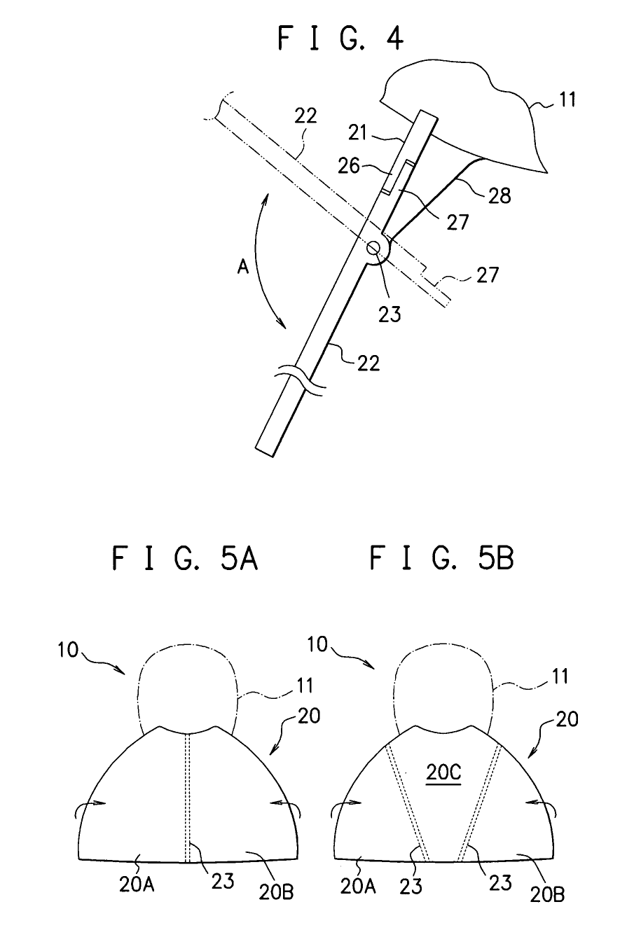

The engaging portion 26 of the upper portion 21 is formed by cutting out the both sides of the inserting holes 24, and thinning a portion thereof at the same time to be a stair-like shape as shown in FIGS. 3A and 3B, and the engaging portion 27 of the lower portion 22 is formed by protruding the upper portion of the inserting hole 25 and thinning a portion thereof to be a stair-like shape. The engaging portions 26 and 27 are put on top of one another as shown in FIG. 4, so that the diving plate 20 is integrated and formed in a flush state with each other as a whole.

It should be noted that a stiffening rib 28 is provided on the back (lower side) of the upper portion 21 of the diving plate 20 in the above case as shown in FIG. 4. By providing the stiffening rib 28, the strength and the stiffness of the diving plate 20 can be ensured, even when the diving plate 20 is made thin. Note that when the diving plate itself already has a predetermined strength or the like, the stiffening rib 28 is not necessarily provided, in other words, it can be selectively adopted.

In the fishing lure of the present invention, after landing of the cast lure 10 on the water, the diving plate 20 receives stream resistance by pulling the line 13, the lure 10 travels under the water in a forward leaning attitude receiving stream resistance. In such a case, it is possible to control so that the lure body 11 performs the desired lure action by adjusting the degree of pull of the fishing line 13.

Especially in the present invention, the diving plate 20 is structured to be bendable. In the normal state, the engaging portions 26 and 27 engage with each other, and the diving plate 20 is kept in a flush state as shown by a solid line in FIG. 1. When casting, the lure 10 flies putting the rear side (tail portion 19) of the lure body 11 ahead. By taking such a flying attitude, the diving plate 20 receives air resistance as shown by an arrow W in FIG. 1, the lower portion 22 of the diving plate 20 pivots around the pin 23 by the air resistance. By bending the diving plate 20, the air resistance at the time of flying is significantly reduced, so that the flying distance of the lure can be remarkably extended. Accordingly, a target point is easily aimed at, in other words, the accuracy of casting is enhanced, and as a result, a high casting performance can be obtained.

Generally, in this kind of lure, it makes an irregular rotational movement or the like by the air resistance during flying, and easily looses its speed unexpectedly if this state is kept as it is. On the contrary, the lure 10 of the present invention suppresses such a rotational movement or the like by reducing the air resistance as described above, and it is possible to enhance the casting accuracy from this point by avoiding such a stall during flying. Note that after landing of the lure 10 on the water, the diving plate 20 gets back to the original state (flush state) by receiving water, and the lure 10 moves round in the water.

Furthermore, in the lure 10 of the present invention, since the diving plate 20 is formed in a thin plate, it is possible to perform a so-called sharp and zippy lure action. In other words, the number of actions (types) performable within a predetermined time period is increased so that a fish-attracting effect can be enhanced.

In addition, if the diving plate 20 comes in contact with an obstacle or the like in the water during moving around in the water, since the diving plate 20 is made to be bendable, it does not oppose against the obstacle or the like, and the lower portion 22 properly pivots. Thereby, creating an irregular and unintentional lure action, it can give a change to the movement of the lure 10. Moreover, when the diving plate 20 comes off from the obstacle after coming in contact with obstacle or the like, it tends to return to the original state. In this instance, it is possible for it to further produce a secondary action-change.

Since the whole diving plate 20 is made of plastic, it has appropriate elasticity and flexibility. Moreover, the upper portion 21 and the lower portion 22 are attached by a pin-connection via the pin 23, which makes it possible for the diving plate 20 to be bent at the connecting portion between both. Therefore, when the diving plate comes in contact with or collides with an obstacle on the earth not limiting to the obstacle in the water, during casting, it is not easily damaged, and excellent in impact resistance.

FIGS. 5A and 5B show modification examples of the lure 10 of the present invention. In the example shown in FIG. 5A, the diving plate 20 is divided into the right portion 20A and the left portion 20B, which are connected via the pin 23, and are structured to be pivotable in the forward direction as shown by the arrow. Other formations are substantially similar to the case of the above-described embodiment.

In the example shown in FIG. 5B, the diving plate 20 is divided into the right portion 20A, the left portion 20B and the central portion 20C. The right portion 20A and the left portion 20B are connected to the central portion 20C respectively via pins 23 and are formed to be pivotable in the forward direction as shown by the arrow.

In the case of these examples in FIGS. 5A and 5B, the diving plate 20 is structured to be bendable, and is kept in a flush state in the normal state. During casting, the right portion 20A and the left portion 20B pivot in the forward direction. Accordingly, similarly to the previous examples, by flying putting the rear side of the lure body 11 ahead, the air resistance during flying is reduced, which makes it possible to extend a flying distance. After landing of the lure 10, the diving plate 20 receives water and moves around in the water.

It should be noted that although preferable embodiments of the present invention has been explained, the present invention is not limited to the above-described embodiments only, and it is possible to make an appropriate modification thereof as necessary.

Since the diving plate 20 (especially the lower portion 22) is a different part from the lure body 11, it is possible to adopt a different material freely. For instance, it is possible to use material of high in strength or high in reflectance, more specifically, metal or carbon. As for the shape or size of the diving plate 20, it is possible to adopt anything suitable for the movement that the lure 10 is aiming at including the examples in the drawings.

According to the present invention, the diving plate is structured to be bendable. In the normal state, the diving plate is kept in a flush state, and at the time of casting, the diving plate receives air resistance by taking a flying attitude putting the rear side ahead and the lower portion pivots around the pin. Then, by bending the diving plate, the air resistance during flying is significantly reduced, so that the flying distance can be remarkably extended. It enhances the degree of casting accuracy and realizes high casting performance.

In addition, by reducing the air resistance, rotational movement or the like caused by the air resistance is suppressed, which avoids a stall during flying. Thus, the degree of the casting accuracy can be also enhanced from this point.

The present embodiments are to be considered in all respects as illustrative and no restrictive, and all changes which come within the meaning and range of equivalency of the claims are therefore intended to be embraced therein. The invention may be embodied in other specific forms without departing from the spirit or essential characteristics thereof.

What is claimed is:

1. A fishing lure provided with a lure body formed in an appearance imitating a small fish in shape, comprising:
a diving plate in the vicinity of the tip of said lure body,
wherein said diving plate is structured to be bendable.

2. The fishing lure according to claim 1, wherein said diving plate is capable of taking a flush state, and at least one portion thereof is bendable so as to be folded toward the front of said lure body.

3. The fishing lure according to claim 1, wherein said diving plate is made to be bendable by pivotably connecting the upper portion and the lower portion of said diving plate relatively to each other, and by vertically pivoting the lower portion in regard to the upper portion fixed on said lure body.

4. The fishing lure according to claim 2, wherein said diving plate is made to be bendable by pivotably connecting the upper portion and the lower portion of said diving plate relatively to each other, and by vertically pivoting the lower portion in regard to the upper portion fixed on said above-described lure body.

5. The fishing lure according to claim 3, wherein said upper portion and said lower portion of said diving plate are attracted to each other by a pin connection, and an engaging portion where the upper portion and the lower portion are put on top of one another in a concave and convex combination state is provided at a portion very close to the connecting point so that said diving plate can be kept in a flush state owing to this connecting portion.

6. The fishing lure according to claim 4, wherein said upper portion and said lower portion of said diving plate are attached to each other by a pin connection, and an engaging portion where the upper portion and the lower portion are put on top of one another in a concave and convex combination state is provided at a portion very close to the connecting point so that said diving plate can be kept in a flush state owing to this connecting portion.
